(19) United States
(12) Patent Application Publication
(10) Pub. No.: US 2006/0008271 A1
(43) Pub. Date: Jan. 12, 2006

(54) Method of failure protection for digital transmission system in ring configuration, and relevant multiplexing device

(75) Inventors: Tung-Cheng Chiang, Hsinchu (TW); Chun-Sheng Chang, Hsinchu (TW); Chang-Yung Lin, Hsinchu (TW)

Correspondence Address: BACON & THOMAS, PLLC, 625 SLATERS LANE, FOURTH FLOOR, ALEXANDRIA, VA, 22314, US

(73) Assignee: Loop Telecommunication International, Inc., Hsinchu (TW)

(21) Appl. No.: 10/887,857

(22) Filed: Jul. 12, 2004

(51) Int. Cl. G02F 1/00

(52) U.S. Cl. 398/3

(57) ABSTRACT

A method of failure protection in a digital transmission system having a plurality of transmission elements connected in a ring configuration over metallic media, said ring configuration being formed by at least two paths, one path as a normal path for the transmission at the normal status, another path as a backup path which forms a closed loop and has no connection with said normal path at the normal status, said normal path and said backup path having opposite transmission directions, said method comprising the step of connecting said normal path and said backup path in said transmission element through hardware when a failure happens in said normal path so as to maintain the transmission. A digital transmission system with less expensive transmission elements and better failure protection can be obtained accordingly.

### BACKGROUND OF THE INVENTION

1. Field of the Invention

The present invention relates to digital transmission systems in telecommunications, more particularly to the failure protection for the digital transmission system in a ring configuration as well as relevant multiplexing devices.

2. Description of the Prior Art

Conventional digital transmission systems have developed to form various standards such as T1, T3, E1, E3, DS3 (Digital Signal 3), SDH (Synchronous Digital Hierarchy), SONET (Synchronous Optical NETwork), etc.

A typical T1 has 24 channels, with each channel having a data rate of 64 Kbps (kilobits per second), and a total data rate of 1.544 Mbps (megabits per second), compared to T3/DS3 with 44.736 Mbps. A typical E1 has 31 channels and a data rate of 2.048 Mbps, compared to E3 with 34.368 Mbps. In SDH, the basic rate is 155.529 Mbps, compared to 51.840 Mbps in SONET.

Signals in T1, T3, E1, E3 and DS3 digital transmission systems are carried primarily over metallic media such as twisted pairs of wires or coaxial cables, compared to SDH and SONET digital transmission systems primarily over optical fibers.

FIG. 1 shows a schematic diagram of a typical digital transmission subnetwork in a ring configuration, which comprises nodes N(1), N(2), N(3) and N(4) connected together through two paths, one as the working path W and the other as the backup path B. The traffic on the working path W flow in one direction, and the traffic on the backup path B flow in the opposite direction.

As shown, each node is formed by an add-drop multiplexing device, which can provide signal access to a local device, a local central office (CO), for example. The multiplexing device at N(1) is adapted to act as the signal source of the subnetwork.

In normal operation, the multiplexing device at N(1) sends the same signals received from the outside of the subnetwork to the working path W and the backup path B, respectively, and integrates the signals received from the working path W and the backup path B to send them out of the subnetwork.

In other nodes than N(1), the multiplexing device operates to judge and select better signals from part of the signals received from the working path W and the backup path B and then send the better signals out of the multiplexing device to a local device. And the multiplexing device operates to send the same signals received from the local device to the working path W and the backup path B, respectively.

For example, as shown, the multiplexing device at N(3) selects part of the signals received from the working path W passing through N(2) and sends them out of N(3) to a local device, and send the same signals received from the local device to the working path W and the backup path B, respectively.

As shown in FIG. 2, if a failure happens between N(2) and N(3), the multiplexing device at N(3) in response will change to receive the signals from the backup path B passing through N(4) so as to maintain the signal transmission between N(1) and N(3).

With such failure protection mechanism, the typical digital transmission system in a ring configuration has been working well. But the add-drop multiplexing devices for use therein are considerably expensive due to their sophisticated designs for performing the judging and selecting operations, which is further aggravated when more working and backup paths are to be used.

Hence, there is a need for a failure protection mechanism for a digital transmission system in a ring configuration to make the system have less expensive add-drop multiplexing devices and substantially equivalent failure protection effect.

### SUMMARY OF THE INVENTION

A general object of the present invention is to provide a method of failure protection for a digital transmission system in a ring configuration, thereby making the system have less expensive add-drop multiplexing devices and substantially equivalent failure protection effect.

According to one aspect, the present invention provides a method of failure protection for a digital transmission system having a plurality of add-drop multiplexing devices connected in a ring configuration through at least two paths, one path as a normal path for the transmission at the normal status, another path as a backup path, said normal path and said backup path having opposite transmission directions, said method comprising the steps of letting said backup path form a closed loop and have no connection with said normal path at the normal status; and connecting said normal path and said backup path within two adjacent multiplexing devices, respectively, when a failure happens between said two adjacent multiplexing devices so as to maintain the transmission.

According to another aspect, the present invention provides an add-drop multiplexing device for a digital transmission system, said multiplexing device being adaptable for connection with other multiplexing devices in a ring configuration through at least two paths, one path as a normal path for the transmission at the normal status, another path as a backup path forming a closed loop and having no connection with said normal path at the normal status, said normal path and said backup path having opposite transmission directions, wherein said multiplexing device connects said normal path and said backup path in cooperation with the same connection in an adjacent multiplexing device when a failure happens between said two adjacent multiplexing devices so as to maintain the transmission.

### BRIEF DESCRIPTION OF THE DRAWINGS

In order to more clearly delineate the above and other features and advantages of the present invention, a further description with reference to the accompanying drawings is given below, wherein:

FIG. 1 shows a schematic diagram of a typical digital transmission subnetwork in a ring configuration;

FIG. 2 shows a schematic diagram of the failure protection operation in the digital transmission subnetwork of FIG. 1;

FIG. 3 shows a schematic diagram of a digital transmission subnetwork in a ring configuration according to one preferred embodiment of the present invention; and

FIG. 4 shows a schematic diagram of the failure protection operation in the digital transmission subnetwork of FIG. 3.

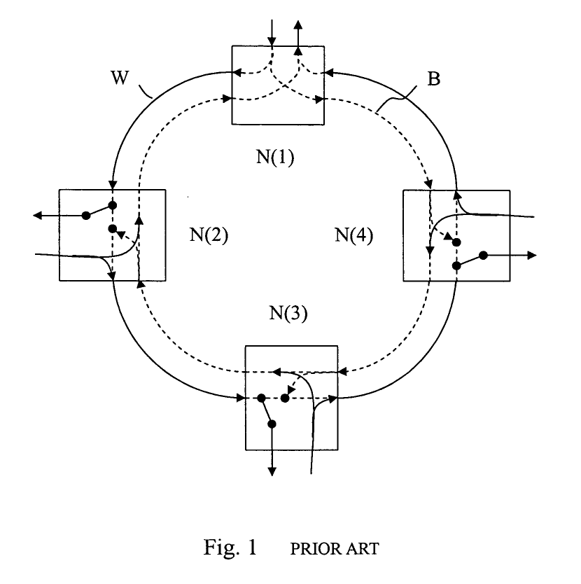

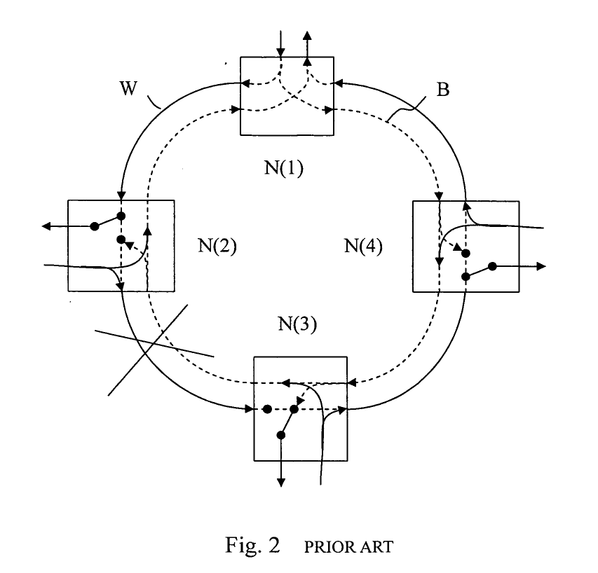

### DETAILED DESCRIPTION OF THE PREFERRED EMBODIMENTS

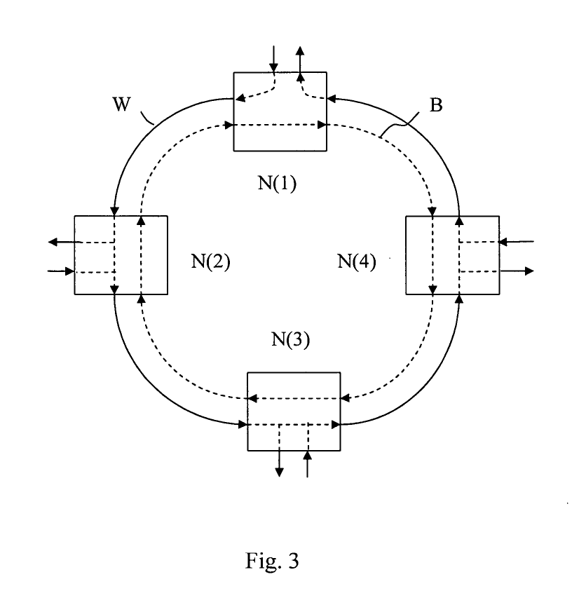

Referring to FIG. 3, schematically shown is a transmission subnetwork according to one preferred embodiment of the present invention, which forms a ring configuration and comprises nodes N(1), N(2), N(3) and N(4) connected together by two paths, one as the working path W and the other as the backup path B. The signal traffic on the working path W flows in one direction, and the traffic on the backup path B flows in the opposite direction.

As shown, each node is formed by an add-drop multiplexing device, which can provide signal access to a local device, a local central office (CO), for example. The multiplexing device at N(1) is adapted to act as the signal source of the subnetwork.

In normal operation, the backup path B forms a closed loop, which may send idle signals or may not send any signal, and has no connection with the working path W.

The multiplexing device at N(1) sends the signals received from the outside of the subnetwork to the working path W through N(2), N(3), and N(4), and then back to N(1) to further send them out of the subnetwork.

In each node, the multiplexing device can operate to send part of the signals on the working path W out of the multiplexing device to a local device. The multiplexing device can also operate to send the signals received from the local device out of the multiplexing device to a next node through the working path W.

For example, as shown, the multiplexing device at N(3) can send part of the signals on the working path W passing through N(2) out of N(3) to a local device, and can send the signals received from the local device out of N(3) to N(4) through the working path W.

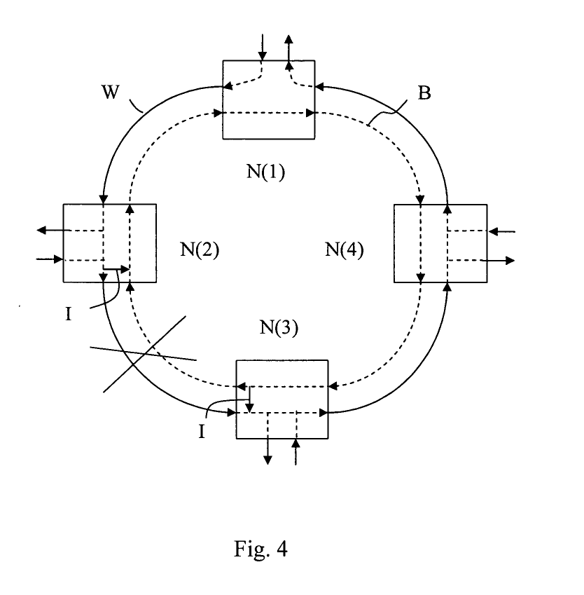

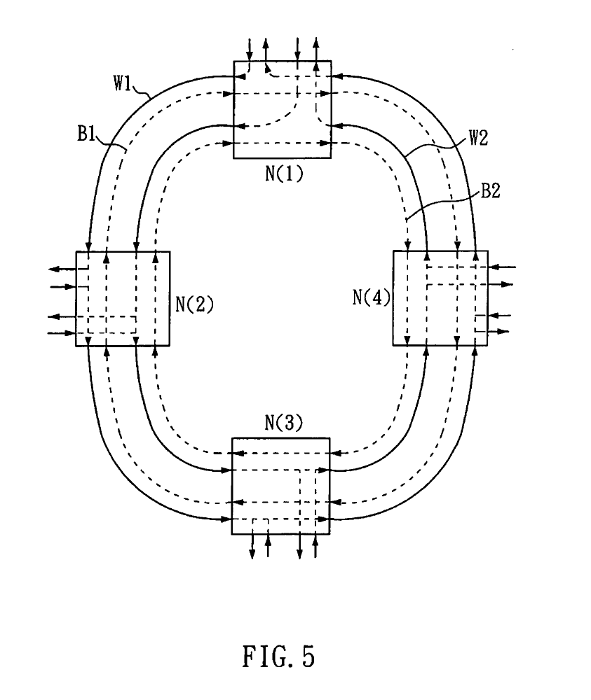

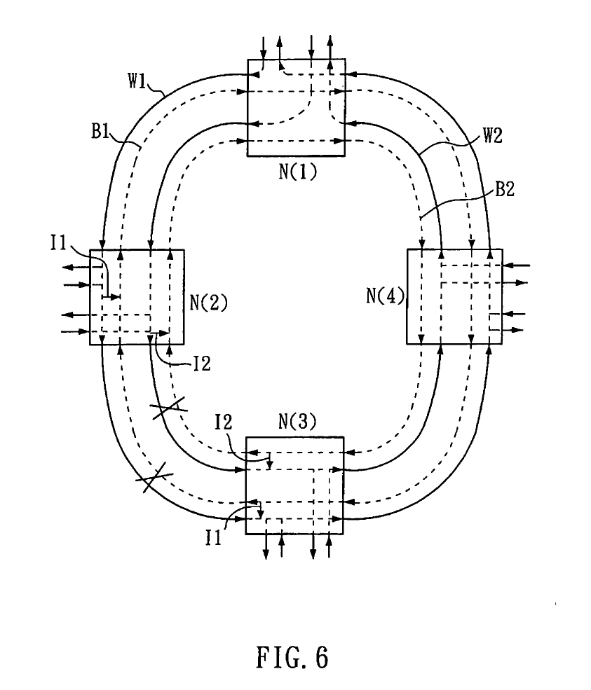

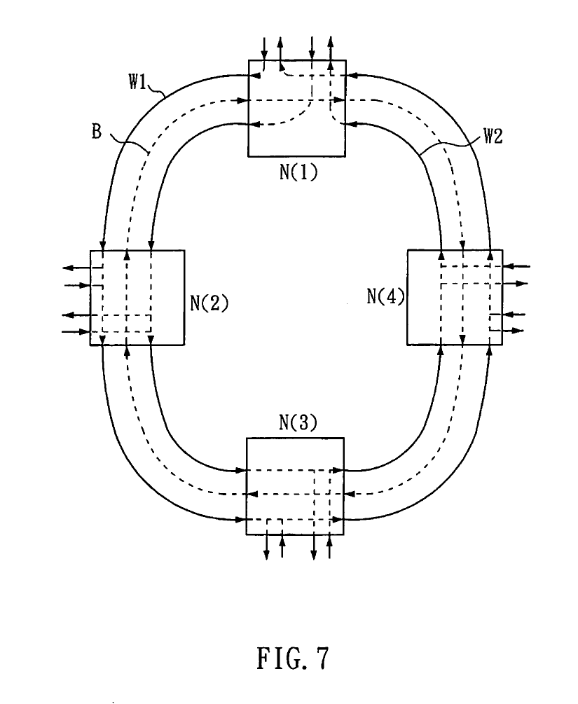

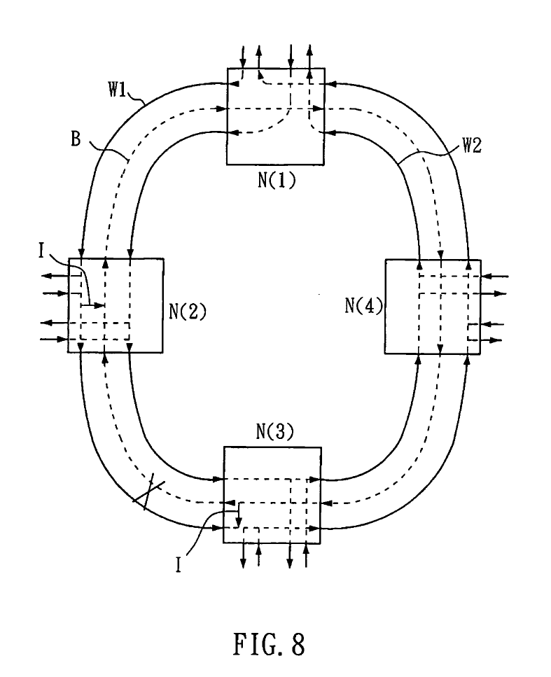

If a failure happens between N(2) and N(3), the working path W and the backup path B within N(2) and N(3), respectively, will be connected through an internal path I, as shown in FIG. 4. Preferably, the internal path I is established at a port of N(2) and N(3), respectively, near the failure location such that N(2) or N(3) can still have access to the local device. In such a way, the signals on the working path W in N(2) will proceed on the backup path B through N(2), N(1), N(4) and N(3), then on the working path W in N(3), and finally back to N(1), thereby maintaining the transmission

The operation of connecting the working path W and the backup path B in N(2) and N(3), respectively, through the internal path I is performed mainly through hardware such as the circuit in a framer in N(2) and N(3), respectively. The connecting operation can be as follows:

1. As the working path W between N(2) and N(3) fails, N(2) will get a Loss of Signal (LOS) alarm and send an Alarm Indication Signal (AIS) alarm through the backup path B immediately;

2. As N(2) gets the LOS alarm, N(2) will initiate the internal path I to form the connection between the working path W and the backup path B to let the traffic in N(2) proceed from the working path W to the backup path B; and

3. As N(3) gets the AIS alarm through the backup path B, N(3) will make the connection between the path W and the path B through the internal path I to let the traffic in N(3) proceed from the backup path B to the working path W.

In addition, from the signals sent out of the subnetwork by N(1), a Network Management System (NMS) (not shown) will record the transmission path (topology) change after the failure protection operation, and indicate the failure change for repair.

A practical test indicated that such failure protection operation can be completed in less than 50 ms (millisecond), and thus has no substantial influence on the normal transmission.

Other details for the above preferred embodiment should be obvious to those skilled in the art, particularly to those skilled in the art of digital transmission systems.

For example, the ring configuration in FIG. 3 can be formed by more than two paths such as four paths. With the four paths, two pairs of working and backup paths can be formed for operation.

With the failure protection mechanism of the present invention, it is apparent that the add-drop multiplexing device for a digital transmission system in a ring configuration can be formed less expensive because of no need for the sophisticated designs for performing the judging and selecting operations as in prior art. The advantage is further amplified when more working and backup paths are to be used. And as verified by the test, a substantially equivalent failure protection effect can be obtained.

Although the present invention has been described in detail with reference to the above-illustrated particular embodiments, it is not intended that such particular embodiments be considered as limitations upon the scope of the present invention except in-so-far as set forth in the following claims.

What is claimed is:

1. A method of failure protection for a digital transmission system having a plurality of add-drop multiplexing devices connected in a ring configuration through at least two paths, one path as a normal path for the transmission at the normal status, another path as a backup path, said normal path and said backup path having opposite transmission directions, said method comprising the steps of:
letting said backup path form a closed loop and have no connection with said normal path at the normal status; and
connecting said normal path and said backup path within two adjacent multiplexing devices, respectively, when a failure happens between said two adjacent multiplexing devices so as to maintain the transmission.

2. The method of claim 1, wherein said digital transmission system is for T1, T3, E1, E3, DS3, or fiber optical transmission.

3. The method of claim 1, wherein the connecting step is performed at a port within said two adjacent multiplexing devices, respectively, near the failure location.

4. The method of claim 1, wherein the connecting step is performed by hardware of said two adjacent multiplexing devices, respectively.

5. The method of claim 1, wherein the ring configuration has four paths, forming two pairs of normal and backup paths.

6. An add-drop multiplexing device for a digital transmission system, said multiplexing device being adaptable for connection with other multiplexing devices in a ring configuration through at least two paths, one path as a normal path for the transmission at the normal status, another path as a backup path forming a closed loop and having no connection with said normal path at the normal status, said normal path and said backup path having opposite transmission directions, wherein said multiplexing device connects said normal path and said backup path in cooperation with the same connection in an adjacent multiplexing device when a failure happens between said two adjacent multiplexing devices so as to maintain the transmission.

7. The multiplexing device of claim 6, wherein said digital transmission system is for T1, T3, E1, E3, DS3, or fiber optical transmission.

8. The multiplexing device of claim 6, wherein the connection of said normal path and said backup path is performed at a port within said two adjacent multiplexing devices, respectively, near the failure location.

9. The multiplexing device of claim 6, wherein the connection of said normal path and said backup path is performed by hardware of said two adjacent multiplexing devices, respectively.

10. The multiplexing device of claim 6, wherein the ring configuration has four paths, forming two pairs of normal and backup paths.

11. A digital transmission system employing the method of claim 1.

12. A digital transmission system employing the add-drop multiplexing device of claim 6.
